(19) United States
(12) Patent Application Publication
(10) Pub. No.: US 2007/0025834 A1
(43) Pub. Date: Feb. 1, 2007

(54) Adapter faceplate

(76) Inventor: John Gustafson, Fall Creek, WI (US)

Correspondence Address: Carl L. Johnson;Jacobson and Johnson, Suite 285, One West Water Street, St. Paul, MN, 55107-2080, US

(21) Appl. No.: 11/540,989

(22) Filed: Sep. 29, 2006

Related U.S. Application Data
(63) Continuation-in-part of application No. 10/877,272, filed on Jun. 25, 2004.
Application No. 10/877,272 is a continuation-in-part of application No. 10/440,649, filed on May 19, 2003, now Pat. No. 7,108,475.

(51) Int. Cl. B66C 23/00

(52) U.S. Cl. 414/723

(57) ABSTRACT

Adapter faceplates that are mountable in an out of the way condition or are removably mounted with the adapter faceplates including a latch member that can be rotated from a latched condition to an unlatched condition.

### CROSS REFERENCE TO RELATED APPLICATIONS

This application is a continuation in part of U.S. patent application Ser. No. 10/877,272 filed Jun. 25, 2004 titled Faceplate, which is a continuation in part of in application titled Faceplate, Ser. No. 10/440,649 filed May 19, 2003.

### STATEMENT REGARDING FEDERALLY SPONSORED RESEARCH OR DEVELOPMENT

None

### REFERENCE TO A MICROFICHE APPENDIX

None

### FIELD OF THE INVENTION

This invention relates generally to attachments and more specifically, mounting adapter faceplates.

### BACKGROUND OF THE INVENTION

Skid steer machines are known and widely used for many tasks. The skid steer machines are compact and lack any steerable wheels. In contrast to machines that have steerable wheels the skid steer maneuvers by stopping or slowing the rotation of one set of side wheels while allowing the other set of side wheels to rotate. The skid steer machines are extremely popular for use in special operations. As a result, a number of different attachments have been created to allow the skid steer machine to perform different tasks. For example, in one application a bucket is attached to the front of the skid steer machine and in another application a blade and in still other applications forks can be attached to allow the skid steer machine to be used as a fork loader.

One of the disadvantages of the skid steer machines is that the skid steer machines are relatively expensive and the equipment used with the skid steer machines is specialized. Consequently, the use of skid steer machines and attachments to skid steer machines is limited to specific industries. Since some skid steer activities are of a one time usage there has developed a market for rental of attachments for skid steer loaders.

A common source of power on a farm is a tractor which has a rear three-point hitch for attachment of farm equipment thereto. Agricultural tractors are well known and can be used as a source of power for various agricultural equipment. The three-point hitch on the tractors are suitable for attaching farm equipment thereto. Unfortunately, the farm tractors are not suitable for use with skid steer attachments. From time to time an owner of an agricultural tractor may need to perform a specific task, which could be performed with an available attachment for a skid steer loader. In addition, tractors often have front-end loaders, which also cannot be used with skid steer attachments.

The inventions described herein address the limited use of the type of equipment such as skid steer attachments with tractors.

### SUMMARY OF THE INVENTION

Briefly, the invention comprise an adapter faceplate that is mountable in an out of the way condition or an adapter faceplate plate that is removably mounted with either of the adapter faceplates including a latch member that can be quickly rotated from a latched condition to an unlatched condition to release an attachment or from an unlatched condition to a latched condition to secure an attachment to the adapter faceplate.

### BRIEF DESCRIPTION OF THE DRAWINGS

FIG. 1 is a perspective view of a faceplate mounted in an out-of-the way condition;

FIG. 2 is a rear view of a faceplate for mounting to a three point hitch;

FIG. 3 is perspective view of a faceplate for removable mounting to a tractor housing;

FIG. 4 is a latch mechanism for securing attachments to a faceplate;

FIG. 5 shows a latch mechanism in an unlatched condition;

FIG. 5A shows the latch mechanism of FIG. 5 in the latched condition;

FIG. 6 shows a further latch mechanism in an unlatched condition;

FIG. 6A shows the latch mechanism of FIG. 6 in the latched condition;

FIG. 7 shows an adjustable latch mechanism in a latched condition; and

FIG. 8 shows the latch mechanism of FIG. 7 in an unlatched condition.

### DESCRIPTION OF THE PREFERRED EMBODIMENT

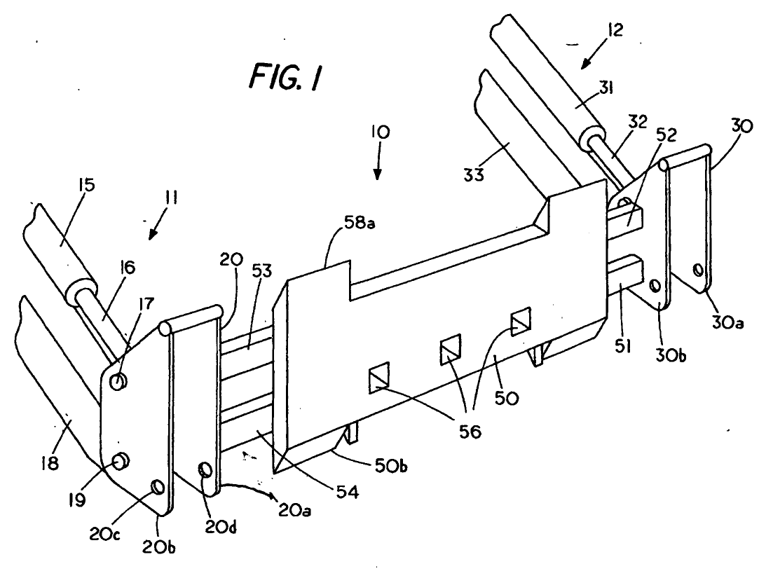

FIG. 1 is a perspective view of an adapter faceplate 10 attached in an out-of-the way condition on housings located on a front-end loader that mounts to a tractor (not shown). Typically, front-end loaders have two arms 11 and 12 that extend outward from opposite sides of the tractor. The arms have hydraulic cylinders that allow one to raise and lower the arms with the equipment attached thereto. In the embodiment shown arm 11 includes a hydraulic cylinder 15 with an extendable and contractible ram 16 that is pivotally mounted to top portion of housing 20 by a pivot pin 17. Attached to the lower portion of housing 20 by a pivot pin 19 is a non-extendable arm 19. Housing 20 contains two spaced apart plates 20a and 20b with an opening 20c in plate 20b and an opening 20d in plate 20a for receiving an attachment. Similarly, located on the opposite side is an identical housing 30a and 30b with a hydraulic cylinder 31 having an extendable ram 32 and a second arm 33 that also attaches to housing 30. Thus one type of equipment such as a scoop or hayfork can be attached to the housings 20 and 30 to allow an operator to raise, lower and dump material that is carried by the scoop or hayfork. Typically such housings and extendible arms can be found in a 7614 loader for a New Holland TV 140 tractor, which is manufactured and sold by New Holland, North America, Inc. New Holland, Pa. USA.

The adapter faceplate 10 which is shown mounted between arms 11 and 12 mimics the attachment used on skid steer machines to enable a second type of attachments that are made for skid steer machines to be used on faceplate 10. That is, faceplate 10 has a front face 50 and a top edge 50a and a lower edge 50b that enable mounting of a second type of attachment such as skid steer equipment. In addition, faceplate 10 includes box housing 56 for securement of other devices thereto.

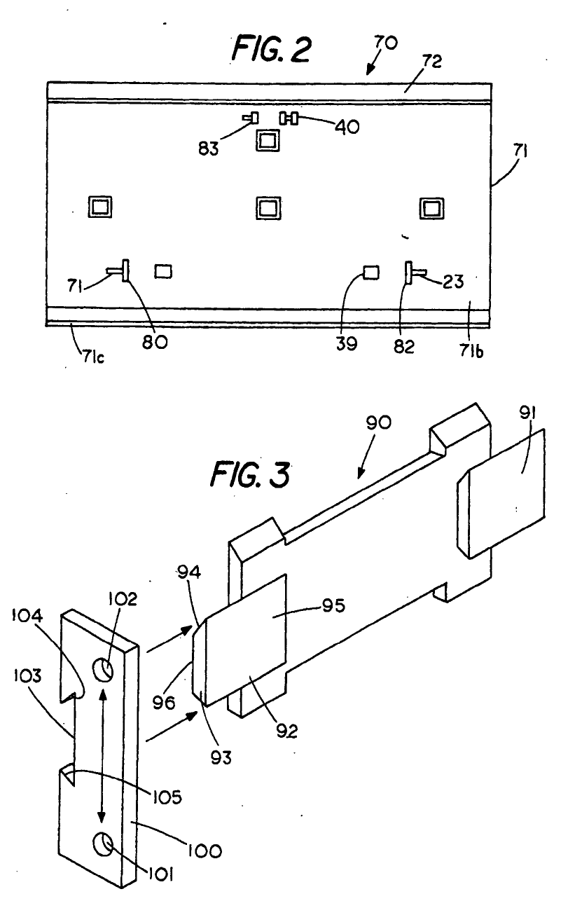

In one embodiment, which is shown in FIG. 2, the faceplate 70 can be attached to a three-point hitch of a conventional tractor to allow a tractor with skid steer attachment. In another embodiment, which is shown in FIG. 1, faceplate 10 can be mounted in an out of the way condition between the manipulateable housings on a tractor front end lift mechanism.

Referring to FIG. 1, faceplate 10 has a rigid member 53 and a rigid member 54 extending from one side of faceplate 10 with the member 53 and 54 secured to housing 20 through fasteners, welding or the like. Similarly, the opposite end of faceplate 10 has rigid members 52 and 51 secured to housing 30 through fasteners, welding or the like.

The faceplate 10 is mounted toward the rear of the housings 20 and 30 so as to be in an out-of-the-way condition and not interfere with the conventional attachment mountable in housing 20 and 30. Thus, the type of equipment that is mounted in conventional attached housing 20 and 30 can be manipulated and operated with the faceplate 10 extending passively therebetween, similarly, if the operator wants to place a skid steer attachment device on the faceplate 10 the housings 20 and 30 extend passively from faceplate 10.

When an operator wants to use a skid steer attachment useable with the faceplate 10 any attachments that are mounted in housing 20 and 30 are removed. Once removed the faceplate 10 can be used to mount a skid steer attachment thereto.

The faceplate 10 is a rigid member having a front side, a back side, with an end side of the ridge member secured to a first movable or manipulateable housing 20 and an opposite end side of the rigid member secured to a further movable or manipulateable housing 30 whereby the faceplate 10 (and the attachments thereto) can be manipulated though manipulation of the first housing 20 and the further housing 30, which are movable though the arms 11 and 12.

With the embodiments shown in FIG. 1 the operator has the option of using either the conventional tractor attachment for housings 30 and 20 or using the skid steer type attachments without having to alter or remove the adapter plate. That is, if an attachment is removed from housings 20 and 30 the operator can immediately connect a conventional skid steer attachment to the faceplate 10 and vice versa.

FIG. 2 shows a rear view of a conventional three-point hitch faceplate 10, which is made of metal. The three-point hitch faceplate 70 comprises a rigid rectangular shaped member 71 having, a rear face 71b and a rearward extending top lip 72 to form mating engagement with a conventional skid steer attachment and a bottom angled lip 71c that engages a locking mechanism to hold an attachment on the three-point hitch faceplate 70. Mounted on the rear face 71b of faceplate 70 is a first connecting member 82 and a second connecting member 80 with connecting members 82 and 80 laterally spaced from each other and secured to the back side 71b of rigid member 71. The first connecting member 82 is connectable to a first tractor mount (not shown) through a pin 83 and the second connecting member 80 is connectable to a second tractor mount (not shown) through a pin 71. A third connecting member 83 is secured to the back side 71b of rigid member 71 with the third connecting member spaced from a straight line connecting the first connecting member 82 and second connecting member 82 to thereby form a portion of a three-point engagement with the rigid plate 71.

The rear three point attachments 80, 82 and 83 allow for the faceplate to mounted directly to the three point hitch as well as allows the faceplate 70 to be removed from the three point hitch.

In contrast to the removable mounting of faceplate 70 the faceplate 10, which is secured to the housings 20 and 30, can remain in place when other attachments are secured to the housings.

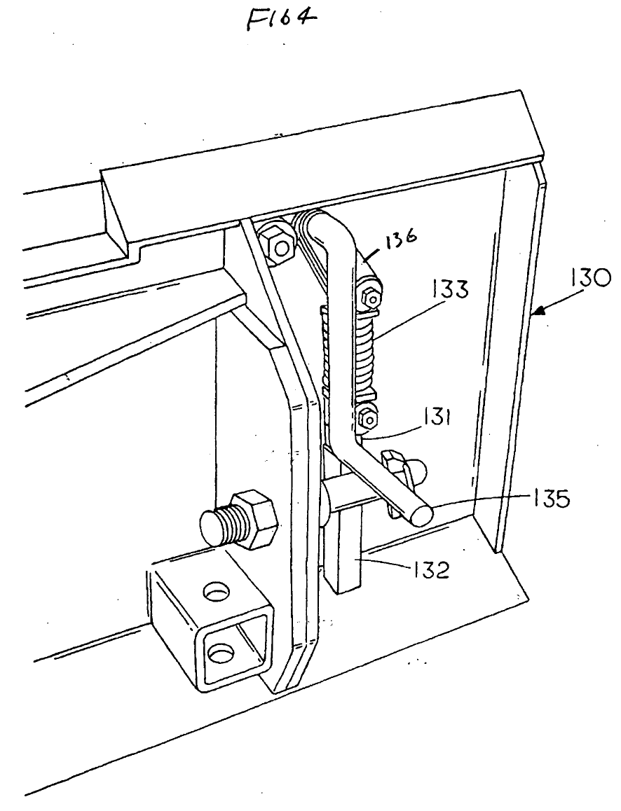

FIG. 3 shows a further embodiment of a faceplate mounting member. The faceplate 90 includes a set of two identical dovetail shaped wings 95 and 91 that are secured to the outer lateral ends of faceplate 90 by welding or the like. Wing 95 has a generally trapezoidal shape recess therein often referred to as a dovetail recess. The wing includes a front surface 92 and a parallel spaced back surface 96 with end face 94 and end face 93 angled toward each other. As wing 91 is identical to wing 95 it is not described herein.

Positioned proximate to wing 95 is a first tractor housing 100 that comprises a rigid plate having a three-sided trapezoidal recess defined by surfaces 102, 104 and 105. The tractor mount trapezoidal recess is dimensioned so as to slide over the dovetail shaped wing 95 with the tractor housing and the wing forming two-way dovetail engagement with each other. The tractor housing 100 can be laterally positioned on wing 95 and an identical tractor housing (not shown) can be similarly laterally positioned on wing 91 to allow one to mount the faceplate 90 to tractor front end loaders that have different spacing between front loader supports on the tractor lift mechanism.

Once the tractor housing 100 is positioned on the wing the tractor housing can be secured to the wing by bolts or the like (not shown) to restrain the tractor housing 105 from lateral displacement with respect to the wing 95. A set of openings 102 and 101 in tractor housing 105 permit one to attach housing 105 to a typical front-end hydraulic loader with manipulateable housings. To mount the faceplate 90 to a different size tractor lift mechanism additional holes can be formed in the tractor housing 100 to accommodate the front loader on other tractors.

Thus the embodiments shown in FIG. 1, FIG. 2 and FIG. 3 show three different methods of attaching a faceplate to a tractor or the like, namely an out of way mounting, a rear removable mounting and a side removable mounting.

FIG. 4 shows a locking device or latch mechanism 130 for locking a skid steer attachment to the three-point hitch faceplate in the unlocked condition. The mechanism includes a member 131 that slidingly extends in housing 132 and can be retracted or extended therein by partial rotation of handle 135 which rotates link 136 to compress spring 133 and force member 131 downward and through housing 132.

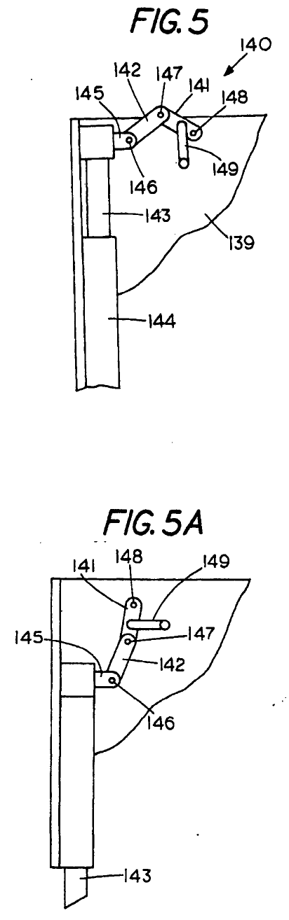

FIG. 5 and FIG. 5A show a two-link faceplate latch member 140 with FIG. 5 showing the latch member in the unlocked or unlatched condition and FIG. 5A showing the latch member in the locked or latched condition. Latch member 140 is mounted to faceplate 139 and to an extendible member 143 that is slideable in housing 144. The link 142 connects to member 145 through a pivot pin 146, and link 141 connects to faceplate 139 through a pivot pin 148 that has one end secured to faceplate 139. A further pivot pin 147 connects link 141 to 142. Attached to link 141 is a handle 149 that allows one to rotate link 141 about its pivot pin 148.

FIG. 5A shows what occurs as link 141 is rotated counter clockwise about pivot pin 148. The rotation pulls member 143 downward through member 145. By selecting the length of the links 141 and 142 so that one can rotate past a straight line condition, that is the link 141 and 142 are not in straight line with each other one can reach a stable position. That is, a clockwise force needs to be applied to handle 149 to bring the link back to the condition shown in FIG. 5.

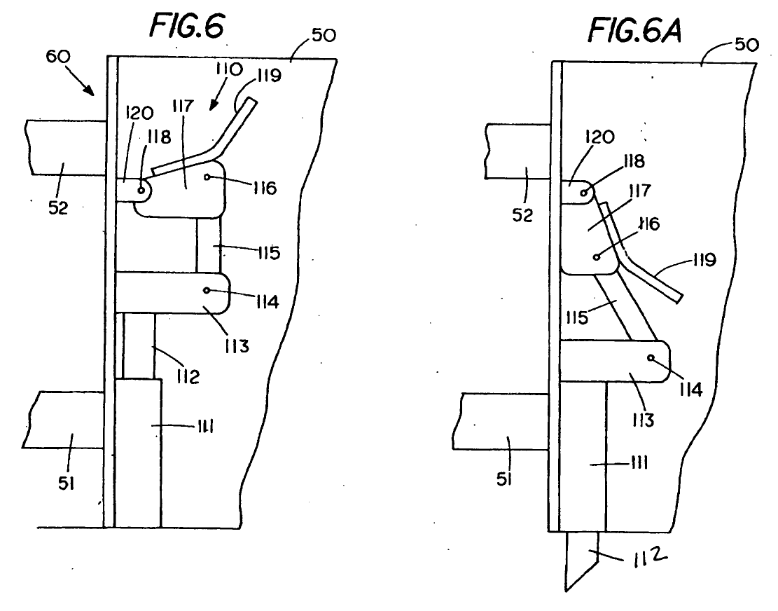

FIG. 6 and FIG. 6A show a further latch mechanism attached to the rear side of faceplate 50. FIG. 6 shows the latch member 10 in the unlatched condition and FIG. 6A shows the latch member in the latched condition.

In the unlatched condition an extendible member 112 slides in housing 111 which is secured to the back of faceplate 50. A link 113 extends outward and connects to link 115 through a pivot pin 114. Similarly, a link 117 connects to link 115 through a pivot pin 116. The other end of link 117 pivotally connects to member 120 though a pivot pin 118. A handle 119 extends outward from link 116 and allow one to rotate link from the unlatchched condition shown in Fugue 6 to the latched condition shown in FIG. 6A.

FIG. 6A shows the latching member in the latched condition. In the latched condition the handle 119 has been pushed downward which forces the extending member 112 downward in housing 111. Handle 119 is pushed until the pivot pints of 118, 116 and 114 have been rotated past a straight line condition. The result is that the links 115 and 116 remain in locked condition unless an upward force or counter clockwise force is applied to handle 119.

Thus with the faceplates shown herein the end side and the opposite end side of the faceplate can be permanently mounted to the first movable housing and a further movable housing of a tractor mounted implement and one can use a latch mechanism for securing an attachment to the faceplate. In one embodiment the latch mechanism includes a pair of links that can be rotated past a straight line condition to maintain the latch mechanism in the latched condition. In the latch mechanism shown in FIG. 6 the links of the latch are located in a general U shaped condition when in the unlatched condition and in a triangular condition when in the latched condition.

Thus the invention includes a faceplate in combination having a first manipulateable housing and a second manipulateable housing; a rigid member, having a front side and a back side; with an end side of the ridge member secured to the first manipulateable housing; an opposite end side of the rigid member secured to the second manipulateable housing whereby the rigid member can be manipulated though manipulation of the first housing and the second housing.

The invention also includes a method of using at least two different types of attachments on a single tractor comprising the step of securing a first and a second manipulateable housing to a tractor; securing an adapter faceplate for receiving a second type of attachment between the first and the second manipulateable housing on the tractor; and securing either a first type of attachment to the first and the second manipulateable housing or a second type of attachment to the adapter faceplate without removing either the manipulateable housings or the adapter faceplate from the tractor.

The method also includes securing the adapter plate between the first and the second manipulateable housing and for latching an attachment to the faceplate by rotating a latch member in a first direction and unlatching an attachment by rotating the latch member in an opposite direction.

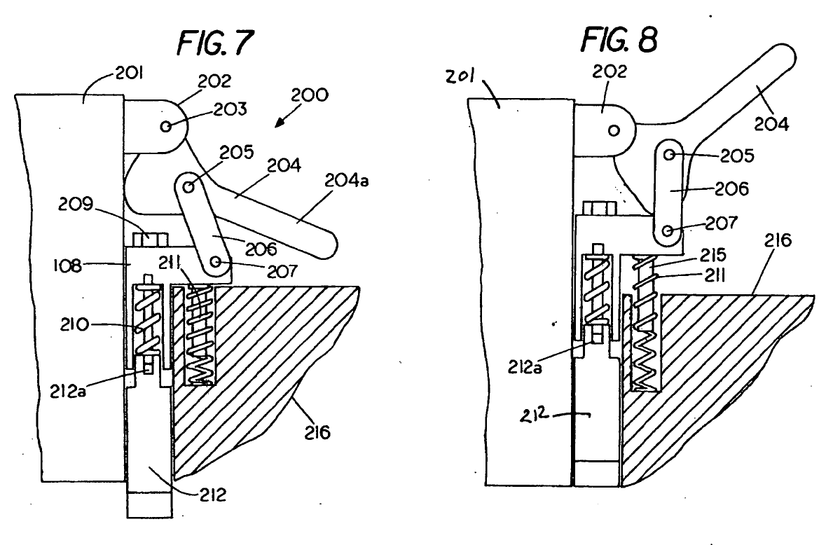

FIG. 7 shows an adjustable latch mechanism 200 in a latched condition; and FIG. 8 shows the latch mechanism of FIG. 7 in an unlatched condition. Latch mechanism 200 comprises a lever 204 having a lever handle 204a. Lever 204 pivotally mounts to frame 201 by an extension 202 having a pivot pin 203 extending between member 202 and lever 204. A link 206 is pivotally connected to lever 204 by pivot pin 205 on one end and on the opposite end of link 206 a pivot pin 207 permits link 206 to pivot thereon. The adjustable latch member 212 is mounted in frame 216 with a compression spring 211 providing a normally upward force on the L-shaped member 108. Member 108 includes a stud bolt 209 with threads thereon for engaging a threaded recess 211a in latch member 212. A compression spring 210 is located around stud bolt 209. Rotation of stud bolt in one direction extends latch member downward and rotation of stud bolt 209 in the opposite direction retracts latch member 212. Thus the stud bolt 209 can be used to adjust the amount the latch member 212 extends from frame 216.

FIG. 7 shows the latch member in the extended condition with the member 212 projecting outward from frame 201. In this condition the lever 204 is in the 4 o'clock or the down position. FIG. 8 shows the lever member in the 2 o'clock position or in the up position. In the up position the latch 211 has been retracted to allow freeing of an attachment from the frame 201. An advantage of the latch mechanism of FIG. 7 and FIG. 8 is that a downward force can be used to latch an attachment to a frame.

In the latched condition the pivot pin 205 has been moved slightly past a centerline between pivot pin 203 and 207 so that an upward or counter clockwise force is required to bring the lever to the unlatched position shown in FIG. 8.

I claim:

1. A faceplate in combination comprising:
a first manipulateable housing and a second manipulateable housing;
a rigid member, said rigid member having a front side and a backside;
an end side of said ridge member secured to the first manipulateable housing; an opposite end side of said rigid member secured to the second manipulateable housing whereby the rigid member can be manipulated though manipulation of the first manipulateable housing and the second manipulateable housing.

2. The faceplate in combination of claim 1 wherein the end side and the opposite end side are removable mounted to the first manipulateable housing and the second manipulateable housing.

3. The faceplate in combination of claim 1 including a latch mechanism for securing an attachment to the faceplate.

4. The faceplate in combination of claim 3 wherein the latch mechanism includes a pair of links that can be rotated past a straight line condition to maintain the latch mechanism in the latched condition.

5. The faceplate in combination of claim 3 wherein the latch mechanism including a handle to bring the links into the latched condition.

6. The faceplate in combination of claim 3 wherein the latch mechanism is located in a general U shaped condition when in the unlatched condition.

7. The method of using at least two different types of attachments on a single tractor comprising the step of:
securing a first and a second manipulateable housing for a first type of attachment to a tractor;
securing an adapter faceplate for a second type of attachment between the first and the second manipulateable housing on the tractor; and
securing either a first type of attachment to the first and the second manipulateable housing or a second type of attachment to the adapter faceplate without removing either of the manipulateable housings or the adapter faceplate from the tractor.

8. The method of claim 7 wherein the adapter plate sides are secured between the first and the second manipulateable housing.

9. The method of claim 7 including the step of latching an attachment on the faceplate.

10. The method of claim 9 wherein the step of latching comprises pushing down on a lever to bring a latch mechanism past a straight-line condition.

11. The method of claim 9 including a step of unlatching an attachment by raising up on lever to bring the latch mechanism into an unlatched condition.

12. The method of claim 7 wherein the adapter plated is welded to the first and the second manipulateable housing.

13. An adapter faceplate comprising
a rigid member, said rigid member securable to skid steer attachments
a first extension on an end side of said ridge member and a second extension n the second side of said rigid member to enable lateral securement of the adapter faceplate to a tractor.

14. The adapter faceplate of claim 13 including a latch mechanism for securing skid steer attachments thereto.

15. The adapter faceplate of claim 13 wherein the first extension has a dovetail shape for mating with a dovetail hosing on a tractor housing.

16. The adapter faceplate of claim 13 wherein the extensions comprises at least two members extending from each side of said rigid member.
